(19) United States
(12) Patent Application Publication
(10) Pub. No.: US 2003/0066670 A1
(43) Pub. Date: Apr. 10, 2003

(54) Electrical cable with grounding device

(76) Inventors: Giuseppe Parise, Rome (IT); Umberto Grasselli, Rome (IT); Luigi Martirano, Cosenza (IT); Luciano Benetti, Rome (IT)

Correspondence Address: MORGAN & FINNEGAN, L.L.P., 345 Park Avenue, New York, NY, 10154-0053, US

(21) Appl. No.: 10/044,318

(22) Filed: Jan. 10, 2002

(30) Foreign Application Priority Data
Oct. 9, 2001 (IT) RM2001A000601

(51) Int. Cl. H01B 7/29

(52) U.S. Cl. 174/36

(57) ABSTRACT

An electric power supply cable comprises a core made up of a conductor coated with a layer of insulating material and enveloped in a second conductor, woven with wire, strands, plait, strap or mesh, which surrounds it concentrically in the form of a sheath. The second conductor is protected and coated with an outer jacket of insulating material and inside the outer jacket there are provided at least two cores, each of which are enveloped in a respective woven conductor.

### FIELD OF THE INVENTION

The present invention relates to a unipolar or multipolar electrical cable provided with a grounding device, in particular for the distribution of electric power and for the supply of low-voltage equipment.

### STATE OF THE ART

A problem that arises in the distribution of electric power and in the supply of low-voltage appliances and equipment for domestic, commercial or industrial use is that of having available a safety system that will guarantee the safety of the users of machines, electrical domestic appliances, lighting systems, etc. and will prevent injury to persons or damage to things in general, in the event of short circuits or faults or failures on the system, whether at the level of the distribution cables or at the level of the domestic appliances and electrical machines themselves. Stringent standards and regulations have been introduced in all countries for the design and installation of electrical plants and systems and for the production of components, equipment, machines and cables that are used therein.

In general, the protection of persons and things in electrical systems (networks, equipment) is implemented by devices that provide for interruption of the supply and by devices that do not envisage interruption of the supply. The most widespread means of protection is via protection devices that provide for automatic interruption of the power supply, such as circuit breakers, automatic cut-outs, residual-current devices and fuses, and for the co-ordination of these devices with the grounding system of all the conductive parts present in the building or in the area of use.

A priority recommendation of current legislation is the use of residual-current devices co-ordinated to the grounding system.

For this reason, the circuits of the electrical systems are made up not only of active conductors but also of protection conductors that make the connection of all the metallic conductive parts present to the grounding-electrode system. In this way, any possible faults or failures between active conductors and conductive metallic parts cause tripping of the protection, so limiting the risk of electric shock for people or the sparking-off of fires due to the presence of electric arcs and local heating.

However, not all the faults involve the conductive parts and/or the protection conductors. Of this type are the faults, (the so-called short circuits) between active conductors, which are protected by circuit breakers or fuses that must be chosen and regulated in such a way as to trip for any short-circuit event that might arise in the system.

A critical case of short-circuiting may occur in the end stretches of the circuits for supplying electrical equipment, especially in extension leads or in mobile cords that remain in sight, which are generally installed mobile and not protected from direct contact with people and things. Even though a protection conductor is present in the cable itself, the fault may not involve the said protection conductor and may take the form of a pure short circuit (i.e., a fault exclusively between active conductors). These events may present such low current values as not to enable tripping of the protection devices at maximum current, also on account of the presence of possible electric arcs that limit their intensity and render them dangerous for the sparking-off of fires.

In some countries, electronic safety devices have been devised and developed which check the behaviour of the current and voltage in the network and detect any possible presence of an electric arc in the circuit, thus interrupting the current. Albeit very effective, these electronic devices act with a certain delay due to the time necessary for the integrated circuit of the electronic device to evaluate the electrical parameters involved. In addition, these devices provide protection only from events characterized by the presence of an electric arc (particular current pattern), constitute sophisticated equipment, and represent a considerable additional cost for the system.

The fault event usually occurs with phenomena of electric arc that limit the current, whilst dead short is generally rare. The minimum value of the fault current depends in practice upon any arc impedance that may be present.

In low-voltage alternating-current electrical systems, pure short circuits with electric arc are to be considered as a weak point of the system also because they may cause sparking-off of a fire or an electric shock, especially in free or “flying” connections, supply cords, extension leads, connections to mobile equipment and internal connections inside equipment.

There exist three basic types of electric arc: on the individual interrupted live conductor (defined as series arc), live-live or live-neutral conductors (defined as parallel arc), and live-ground conductors (defined as ground arc). Of course, there may also exist arcs of a mixed type.

The characteristic of intermittence of the electrical parameters of the arc enables normal protection devices, fuses and circuit breakers, adequately coordinated with the parameters of the circuit, to guarantee, via magnetic tripping or without intentional delay, only a protection of a probabilistic type, as first level of protection of the circuit against electric arcs.

The standards currently in force in Europe contemplate a “general” protection of the cables from this type of fault, as well as thermal tripping or inverse-time delayed tripping, which proves ineffective for “local protection in the fault point”, precisely on account of the intermittent character of the electric arc when it occurs.

### SUMMARY OF THE INVENTION

Consequently, the purpose of the present invention is to overcome the problems referred to above, which are presented by devices for grounding low-voltage cables, by providing an electrical cable with a grounding device that is effective for eliminating dangerous situations generated by short circuits that occur in a network for distribution of low-voltage electric power supply and in the equipment and devices connected up to these networks.

A primary purpose of the present invention is to provide a cable of simple construction using commonly employed technologies for the production of electrical cables.

A further purpose of the invention is to provide a new type of cable with a grounding device that meets the standards and regulations currently in force, whilst remaining economically advantageous in terms of production costs. Yet another purpose of the present invention is to provide a cable that will be much more effective in resolving situations of short-circuiting of cables of the state of the art, which are generally difficult to solve.

These purposes are achieved by an electrical cable with a grounding device, in particular for the distribution of low-voltage electric power, in accordance with claim 1.

In the cable according to the invention, each active conductor, whether live or neutral, is innovatively envisaged as individually shielded by a concentric conductor with functions of a protection conductor. In this way, live-live and live-neutral faults are forcedly converted into a live-ground fault or a fault of a mixed type. As a result, this protection system can be guaranteed by using the special cables which form the subject of the invention co-ordinated with residual-current protection devices which are already extensively installed and which, in many cases, are resolutive for protection from indirect contacts. These cables are especially suited for industrial, commercial, service-sector and residential environments, and for all wiring that is exposed to mechanical damage or stress of some other type, such as mobile circuits, circuits for supplying equipment that is not fixed, supply cords, extension leads, and internal connections inside equipment.

The cable proposed by the present invention behaves like a special component of Class I, according to the IEC 60364 international standards, since the concentric protection conductor constitutes a conducting part with function of a “guard conductor”, which is to be connected to the grounding system and is to co-ordinate the latter with an appropriate protection. The function of guard conductor is that of preventing a direct contact between the active conductor and the outside environment, without the mediation of the protection conductor. In this way, interruption of the supply is activated; namely, the protection required for components of Class I is provided. The presence of the outer protective sheath guarantees protection for double-insulation components of Class II, which is typical of cables provided with sheaths. At any possible decay of the barrier of the double insulation (degradation of the sheath), the cable is still protected as a Class I component.

Any type of fault that may occur inside the special cables according to the invention will certainly be characterized by a component with current “forced” to ground (residual current), which, as such, is more easily detectable than an overcurrent of limited amount. In this way the possibility can be ruled out of a pure short-circuit event between active conductors, and any fault inside the cable may be effectively detected and protected by the residual-current device for the TT or TN systems or by the insulation controller for the IT systems, defined according to the aforesaid IEC standard.

Considering the need for a sensitive and adequate residual-current protection in electric wiring systems with the TT or TN system or for a continuous control of insulation of the circuits in IT systems, the advantage in the use of the cable according to the invention as compared to normal cables may therefore be summed up in the possibility of using the residual-current protection also for “forced to ground” short-circuit faults, series and parallel arcs that involve all the circuits and connections made with the same cables that form the subject of the present invention.

The most common residual-current devices ensure tripping for alternating sinusoidal currents, but there are also available residual-current devices that ensure tripping also for continuous pulsating residual currents, as in the case of an electric arc that is self-limiting to the duration of a half-cycle.

The use of the cable according to the invention is particularly suited for use in new wiring systems and new electrical equipment, as well as for making power-supply cords, extension leads and for all mobile connections, including all existing ones that may be easily replaced.

Consequently, this protection device solves all the cases of critical short-circuiting with low current values.

### BRIEF DESCRIPTION OF THE FIGURES

Further characteristics and advantages of the invention will become more apparent in the light of the detailed description of a preferred, but not exclusive, embodiment of an electrical cable with a grounding device, in particular for the distribution of low-voltage electric power, illustrated purely by way of non-limiting example, with the aid of the annexed plates of drawings, in which:

FIG. 1 represents a cut-away view of the cable according to the invention;

FIG. 2 represents a graph with the plot of an event of an intermittent electric art in a cable of the type according to the invention which occurs as for the function (a), and in case it is detected by the residual-current-operated circuit breaker which ensures tripping also for continuous pulsating residual currents (b);

FIG. 3 represents the plot of the current with a cable according to the invention in a situation where it is subject to an event that is likely to cause damage;

FIG. 4 represents a graph with the plot of the electrical parameters for the case of a known cable of the state of the art;

FIG. 5 represents a graph of the plot of the electrical parameters in the case of the cable according to the invention; and

FIG. 6 represents the equipment used for carrying out the tests on the cable according to the invention.

### DETAILED DESCRIPTION OF PREFERRED EMBODIMENTS OF THE INVENTION

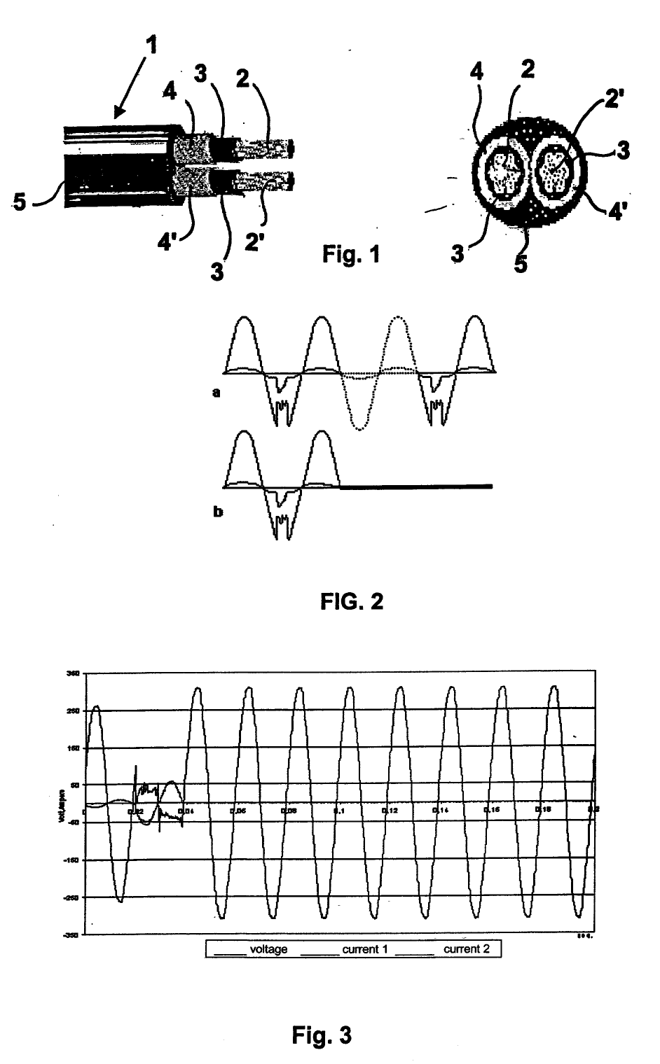

The cable according to the invention, which is designated as a whole by the reference number 1, may be of the unipolar or multipolar type, and in particular in the embodiment illustrated in FIG. 1 is bipolar, and provides for each conductor 2, 2′, whether this be an active conductor, a live conductor or a neutral conductor, an insulating coating 3 of its own and a conductor 4 with the function of external protection, which is concentric on each individual core. In the ensuing description, we shall define as core of the cable each active conductor 2, 2′, whether this be a live conductor or a neutral conductor, with an insulating coating 3 of its own. The cable is completed by an outer insulating sheath 5.

Also in the case of a multipolar cable, including cables with poles numbering more than two, an external protection conductor 4 is set around each of the individual cores.

In another embodiment, the conductor 4 is set on at least n−1 of the cores. The absence of a concentric conductor on a core (designed preferably for use as neutral) leads to the advantages of a lower cost and greater manoeuvrability. The use of the concentric protection conductor on the live conductor, co-ordinated with a residual-current device or insulation controller, ensures an effective protection from terminal short-circuit events, even in the case of low-current values and/or with the presence of parallel electric arc but not series electric arc on the conductor without shielding.

The active conductor 2, 2′ may be made either rigid or flexible, of the type, for instance, with a round flexible cord made of annealed red copper, a rigid cord made of tin-plated copper, or a single wire made of tin-plated copper. The insulator 3 which surrounds each of the active conductors 2, 2′ is made of plastomeric material, for example of the PVC type, or elastomeric material, of the high-modulus EPR type, a cross-linked elastomer, or natural or synthetic rubber, or may be made of other materials used as insulators for low-voltage electrical cables.

The external-protection conductor 4, 4′, concentric to each individual insulated active conductor and set on the outside of the insulator 3, has shielding functions and is formed by wires made of conductive material, such as stranded non-tin-plated annealed copper.

The outer sheath 5 envelops the two cores, each surrounded by an external-protection conductor 4, 4′ of its own, in grouped form and with the surfaces of the external-protection conductors in contact with one another, and moreover fills the remaining gaps thereof. The said sheath 5 is made of PVC or polyethylene or polychloroprene, or natural or synthetic rubber, or other plastomer or elastomer used in the production of sheaths for low-voltage electrical cables.

The operating temperature, emergency temperature, short-circuiting temperature, and the behaviour of the cable in regard to fire, such as the non-propagation of flames, non-propagation of fire, reduced emission of corrosive gases, very reduced emission of opaque fumes and toxic gases and absence of corrosive gases, and resistance to fire, depend upon the materials used for the insulator 3 and the sheath 5, in compliance with national and international standards currently in force.

The cable may be made with active conductors having the commonly adopted standard sections, and meets the requirements contemplated by national and international standards, for example IEC.

The external-protection conductors 4, 4′ have an equivalent total section not smaller than the minimum, allowed by the reference standards, for the protection conductor. In the multipolar cable, advantageously the external-protection conductors 4, 4′ are arranged so as to be in direct contact with one another.

The high number of strands of each external-protection conductor 4, 4′ keeps the cable 1 flexible like normal electrical power cables of equal nominal section, guaranteeing at the same time an adequate protection against mechanical stresses.

The cable according to the invention is suited in the distribution of low-voltage electric power both for fixed installations and for installations of a mobile type, whether in sight or chased in pipes or protected ducting.

In particular, the cable according to the invention is suited for mobile installations where it is subject to mechanical stresses or stresses of another type, such as extension leads and cords for supplying fixed and mobile equipment, and also in the execution of wiring systems, parts of systems and non-fixed terminal circuits, in commercial, service-sector and residential buildings, in industrial applications and in temporary mobile work-sites. In addition, it is suited for internal connections of electrical equipment.

The cable may be used also for fixed installations either in view or set in set in chased pipes or ducts, or similar closed systems.

Operation of the cable according to the invention, in the event of a dead short or a series or parallel-arc fault, whether of the live-live or live-neutral type, on a cable, irrespective of its mode of installation, is as follows. When such an event occurs, there generally also occurs breakdown of the insulator 3, and a direct contact trips between the external-protection conductor 4, 4′ and the corresponding conductor 2, 2′, thus causing circulation of a residual current between the two. In this way, the fault is protected by an adequate residual-current protection device, of the type used for systems with neutral connected to ground or by the insulation controller for the systems with insulated neutral, which trips as soon as said contact occurs.

FIG. 2 illustrates the process involved in an intermittent electric-arc event in a cable of the type according to the invention, which occurs as for the function (a), and in case it is detected by the residual-current-operated circuit breaker which ensures tripping also for continuous pulsating residual currents (b).

As shown in FIG. 2, fast tripping is of fundamental importance for preventing restarting of the arc, locally limiting the electric power associated to the event to very low values, and hence reducing the risk of fire, as well as for preventing electric shock linked to the possibility of contact with the conductor coated with a deteriorated insulator.

These faults may in general be caused in various ways, frequently on account of improper behaviour of users of the system and equipment. Typical situations that give rise to the aforesaid faults may be damaging of the cables due to mechanical stress, cutting by sharp edges, perforation by nails, drills, etc., loosening of the connections, wear of the insulation of the cables, overheating or thermal stress of extension leads and of circuits, or damage due to action of chemical or corrosive agents.

The cable according to the invention increases the degree of protection against the above-mentioned dead-short events and parallel-arc and series-arc events of all the electrical circuits and connections in which it is used. The degree of protection is increased in particular in the case of faults characterized by low-current values, which are hard to detect with the commonly used overcurrent protections and which lead to situations involving a high risk of fire, and also in the case of faults which are such as not to cause opening of the protection, because this is anticipated by self-extinction of the arc itself, and which thus lead to situations involving a high risk of electric shock for people.

The electric cable that forms the subject of the invention is designed to be used for the distribution of low-voltage electric power in all types of distribution systems, and in particular for the distribution in terminal systems or networks, whether in the industrial sector or in the commercial, tertiary or residential sectors. It is also adequate for cords and connections for supplying fixed and mobile electrical equipment, for extension leads and cord-storage devices, for cables installed in sight, for cables for mobile use, and for cables for plugs with integrated residual-current devices.

The tests conducted with cables according to the invention yielded the results appearing in the table below. The cable used for the test was made in the bipolar form, made up of two unipolar cables with sections of 1.5 and 2.5 mm² and PVC 105 insulator having a thickness of 0.7 mm.

Considering use of this type of cable in the electrical field in compliance with the Italian standard CEI 20-20, it was found that the cable resisted a voltage of 2000 V and a frequency of 50 Hz for 5 minutes without undergoing any perforation. It proved suitable for electrical use in circuits with a voltage of 220-240 V.

The technical specifications of the bipolar cable used in the tests appear in the two tables below:

| | Outer | | | | | |
|---|---|---|---|---|---|---|
| | jacket/ | | | Formation | | |
| | diameter | Weight | Operating | of conductor | Section | Type of |
| Cable | (mm) | kg/100 m | Temp. (° C.) | and shield | mm² | insulator |
| 2 × 1.5 mm² | PVC/5.2 | 5.6 | −20°/+80° | 7 × 12 × 0.15 | 1.5 | PVC |
| 2 × 2.5 mm² | PVC/5.7 | 7.07 | | 7 × 20 × 0.15 | 2.5 | PVC |

CAPACITANCE OF 10-m LONG CABLE

| | | C (nF) | R (Ω) | f (kHz) |
|---|---|---|---|---|
| 2.5-mm² CABLE | R-C parallel | 6.37 | 25000 | 1 |
| | | 5.76 | 2800 | 10 |
| | | 4.86 | 326 | 100 |
| | R-C series | 6.4 | 24900 | 1 |
| | | 5.7 | 2800 | 10 |
| | | 4.9 | 325 | 100 |
| 1.5-mm² CABLE | R-C parallel | 4.52 | 723000 | 1 |
| | | 4.15 | 56600 | 10 |
| | | 3.68 | 5100 | 100 |
| | R-C series | 4.53 | 1700 | 1 |
| | | 4.17 | 2580 | 10 |
| | | 3.72 | 35 | 100 |

In particular, the values of capacitance that were measured ensure the absence of untimely tripping as a result of homopolar currents in the cable itself.

Tests carried out have enabled verification of the fact that the cable according to the invention is effectively able to prevent short-circuit situations with low-current values such as typically occur in the case of “arc-faults”.

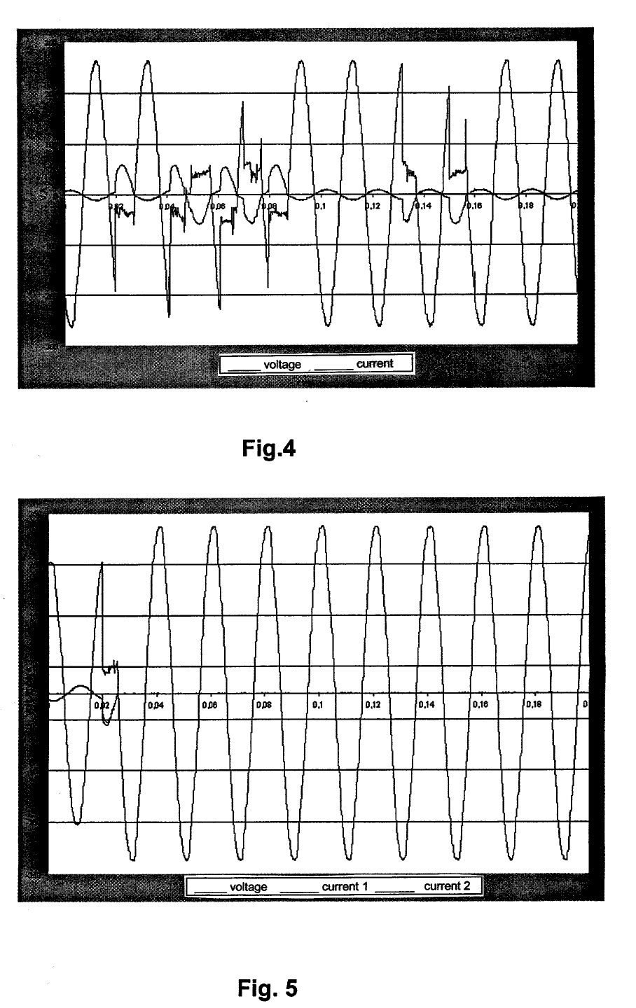

The two graphs appearing in FIGS. 3 and 4 show the plots of the electrical parameters for the case of a known cable of the prior art and for the case of the cable according to the invention, respectively.

The graph appearing in FIG. 3 represents the current and voltage in the case of a fault that occurs in a commonly used three-pole cable (phase, neutral and external protection). In this case the arc continued to evolve with extinctions and subsequent restartings, without producing tripping of the magnetothermal protection, the value of the fault current being very limited. The external-protection conductor was not involved in the fault so that the residual-current protection was not able to trip.

The graph of FIG. 4 represents the recording of a fault on a cable according to the invention. The curves show the plots of the voltage upstream of the residual-current protection, of the current of the phase conductor and of the protective conductor. In this case, the fault current immediately reaches the shield of the external-protection conductor 4, 4′, enabling instantaneous tripping of the residual-current device of an AC type (current 1 in the phase conductor and current 2 in the protective conductor). After a complete cycle the residual-current device that opens the circuit trips, thus isolating the faulty cable and preventing any risks of contact or fire.

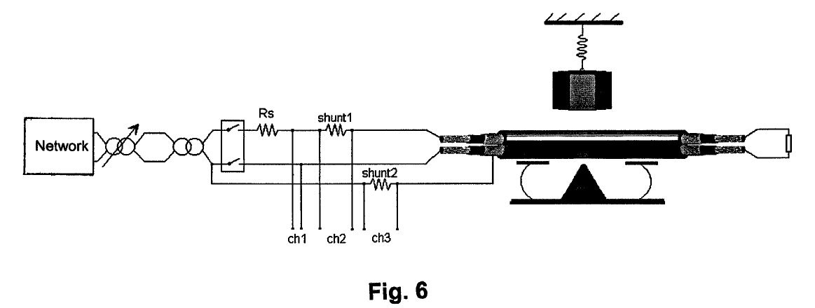

The graph of FIG. 5, instead, highlights a fault that occurs on the cable according to the invention extinguished by a residual-current device of type A, i.e., a residual-current device the tripping of which is ensured also on unidirectional pulsating components.

It clearly emerges that tripping has been instantaneous, producing a de-energizing effect on the arc. With the use of residual-current devices of the AC type for sinusoidal currents, tripping occurs after one cycle.

FIG. 6 illustrates the circuit used for testing faults resulting from mechanical stresses on the cable. By means of the circuit as illustrated in the figure and using a digital oscilloscope, numerous fault events were simulated with the presence of electric arc, caused by mechanical damage, and the plots of the voltage on channel 1 (ch1) and of the current of the phase conductor on channel 2 (ch2) and of the protective conductor on channel 3 (ch3) were recorded in detail.

1. Cable of indefinite length for supply of electric power comprising a core made up of a conductor coated with a layer of insulating material, characterized in that said core is then enveloped in a woven second conductor that surrounds it concentrically like a sheath.

2. Cable according to claim 1, wherein said core, enveloped in a second conductor, is protected and coated with a outer sheath of insulating material.

3. Cable according to claim 2, wherein the cable is provided inside said outer sheath with at least two cores each enveloped in a respective second conductor.

4. Cable according to claim 3, wherein said second conductors are in direct mutual contact.

5. Cable according to claim 4, wherein three or more cores are provided, each enveloped in a respective second conductor.

6. Cable according to the foregoing claims wherein said first conductor is made of flexible metal material.

7. Cable according to the foregoing claims wherein said second conductor is adapted to be grounded to provide a function of protection in the event of fault of the cable.

8. Cable according to the foregoing claims, wherein said insulator and/or sheath is made of plastomeric or elastomeric material.

9. Cable according to the foregoing claims, wherein said second conductor is woven with yarn, strands, plait, strap or mesh.

10. System or network for distribution of electric power made of one or more cables according to any one of claims 1 to 9.

11. Electric power supply system inside equipment made up of one or more cables according to any one of claims 1 to 8.
